(19) United States
(12) Patent Application Publication
(10) Pub. No.: US 2023/0348251 A1
(43) Pub. Date: Nov. 2, 2023

(54) FORKLIFT OVERTURNING PREVENTION METHOD AND FORKLIFT

(71) Applicant: Sany Marine Heavy Industry Co., Ltd., Zhuhai (CN)

(72) Inventor: Shuang LIANG, Zhuhai (CN)

(73) Assignee: Sany Marine Heavy Industry Co., Ltd., Zhuhai (CN)

(21) Appl. No.: 18/349,056

(22) Filed: Jul. 7, 2023

Related U.S. Application Data
(63) Continuation of application No. PCT/CN2021/084592, filed on Mar. 31, 2021.

(30) Foreign Application Priority Data
Jan. 27, 2021 (CN) 202110111761.4

(51) Int. Cl. B66F 17/00

(52) U.S. Cl. CPC B66F 17/003

(57) ABSTRACT

A forklift overturning prevention method includes: acquiring a wheel load on a wheel of a forklift; obtaining a center of gravity of the forklift based on wheel loads on all wheels of the forklift; and sending a protection operation instruction when the center of gravity reaches a preset boundary line, so that the forklift stops working and sounds an alarm to prevent the forklift from overturning.

### CROSS-REFERENCE TO RELATED APPLICATIONS

The present application is a continuation application of International Application No. PCT/CN2021/084592 filed on Mar. 31, 2021, which claims priority to Chinese Patent Application No. 202110111761.4 filed on Jan. 27, 2021. Both applications are incorporated herein by reference in their entireties.

### TECHNICAL FIELD

The present disclosure relates to the field of forklift technologies, and in particular, to a forklift overturning prevention method, and a forklift.

### BACKGROUND

Loading and unloading of goods by a forklift is a common means of transportation. However, the forklift is prone to overturning due to a mechanical structure of the forklift and a carrying method. According to a forklift overturning prevention method in the prior art, only overturning in the front and rear directions is detected and prevented, ignoring the more dangerous left and right lateral overturning. Therefore, there is a need for a forklift overturning prevention method, which may detect a status of stability of the forklift in all directions in real time and prevent overturning of the forklift in all directions.

### SUMMARY

In view of this, possible implementations of the present disclosure provide a forklift overturning prevention method, and a forklift, to solve a technical problem in the prior art that left and right lateral overturning of a forklift cannot be effectively prevented.

According to an aspect of the present disclosure, a forklift overturning prevention method is provided in a possible implementation of the present disclosure, including: acquiring a wheel load on a wheel of a forklift; obtaining a center of gravity of the forklift based on wheel loads on all wheels of the forklift; and sending a protection operation instruction when the center of gravity reaches a preset boundary line.

In a possible implementation, the acquiring a wheel load on a wheel of a forklift includes: acquiring strain data for an axle housing of a steering axle, where the steering axle is configured to connect a drive shaft of the forklift and the wheel of the forklift; and converting the strain data into the wheel load, where the larger the strain data, the greater the wheel load.

In a possible implementation, the acquiring a wheel load on a wheel of a forklift includes: acquiring an axial pressure on a steering knuckle shaft of the forklift; and converting the axial pressure into the wheel load, where the greater the axial pressure, the greater the wheel load.

In a possible implementation, the obtaining a center of gravity of the forklift based on wheel loads on all wheels of the forklift includes: acquiring wheel load information values for four wheels respectively based on wheel loads on the four wheels of the forklift; and determining the center of gravity based on the wheel load information values for the four wheels, where a position of the center of gravity is shifted to a position of a wheel corresponding to a larger wheel load information value.

In a possible implementation, the determining the center of gravity based on the wheel load information values for the four wheels includes: acquiring, based on wheel load information values for two wheels of the four wheels, a first line of center of gravity perpendicular to a connection line of the two wheels, where a ratio of distances from the two wheels to the first line of center of gravity is corresponding to a ratio of the wheel load information values for the two wheels; acquiring, based on wheel load information values for the other two wheels of the four wheels, a second line of center of gravity perpendicular to a connection line of the other two wheels, where a ratio of distances from the other two wheels to the second line of center of gravity is corresponding to a ratio of the wheel load information values for the other two wheels; and determining an intersection point of the first line of center of gravity and the second line of center of gravity as the center of gravity.

In a possible implementation, the obtaining a center of gravity of the forklift based on wheel loads on all wheels of the forklift includes: acquiring wheel load information values for four wheels respectively based on wheel loads on the four wheels of the forklift; and obtaining the center of gravity of the forklift based on weights of the four wheels and the wheel load information values for the four wheels, where the weights of the four wheels are preset based on positions of the four wheels.

In a possible implementation, the preset boundary line includes a combination of one or more of the following: a connection line of two front tires, a connection line of two rear tires, a connection line of two left tires, and a connection line of two right tires.

In a possible implementation, the sending a protection operation instruction when the center of gravity reaches a preset boundary line includes: when the center of gravity reaches the connection line of the two front tires, sending a protection operation instruction corresponding to forward overturning of the forklift.

In a possible implementation, the sending a protection operation instruction when the center of gravity reaches a preset boundary line includes: when the center of gravity reaches the connection line of the two rear tires, sending a protection operation instruction corresponding to backward overturning of the forklift.

In a possible implementation, the sending a protection operation instruction when the center of gravity reaches a preset boundary line includes: when the center of gravity reaches the connection line of the two left tires, sending a protection operation instruction corresponding to leftward overturning of the forklift.

In a possible implementation, the sending a protection operation instruction when the center of gravity reaches a preset boundary line includes: when the center of gravity reaches the connection line of the two right tires, sending a protection operation instruction corresponding to rightward overturning of the forklift.

In a possible implementation, the obtaining a center of gravity of the forklift based on wheel loads on all wheels of the forklift includes: when a sum of wheel loads on two wheels located on a first side is less than or equal to a first preset value, determining that the center of gravity is located on a preset boundary line on a second side, where the first side and the second side are opposite sides of the four wheels of the forklift.

In a possible implementation, the protection operation instruction includes: performing playback of a warning voice for forklift forward overturning, an operation of prohibiting a forklift boom from extension, and an operation of retracting a forklift boom; or performing playback of a warning voice for forklift backward overturning, an operation of prohibiting a forklift boom from retraction, and an operation of extending a forklift boom; or performing playback of a warning voice for forklift leftward overturning, a stopping operation of a forklift boom, and an increase in right counterweight torque; or performing playback of a warning voice for forklift rightward overturning, a stopping operation of a forklift boom, and an increase in left counterweight torque.

According to another aspect of the present disclosure, a possible implementation of the present disclosure provides a forklift, including: a forklift body for handling a material; a forklift overturning prevention apparatus disposed on the forklift body, configured to perform the forklift overturning prevention method according to the foregoing aspect; and a controller disposed on the forklift body and electrically connected to the forklift overturning prevention apparatus, configured to control the forklift body to perform a protection operation when a protection operation instruction sent by the forklift overturning prevention apparatus is received.

According to still another aspect of the present disclosure, a possible implementation of the present disclosure provides an electronic device, including: a processor; a memory; and computer program instructions stored in the memory, where when the computer program instructions are run by the processor, the processor is configured to implement the forklift overturning prevention method, the method including the follow steps: acquiring a wheel load on a wheel of a forklift; obtaining a center of gravity of the forklift based on wheel loads on all wheels of the forklift; and sending a protection operation instruction when the center of gravity reaches a preset boundary line.

In a possible implementation, the acquiring a wheel load on a wheel of a forklift includes: acquiring strain data for an axle housing of a steering axle, where the steering axle is configured to connect a drive shaft of the forklift and the wheel of the forklift; and converting the strain data into the wheel load, where the larger the strain data, the greater the wheel load.

In a possible implementation, the acquiring a wheel load on a wheel of a forklift includes: acquiring an axial pressure on a steering knuckle shaft of the forklift; and converting the axial pressure into the wheel load, where the greater the axial pressure, the greater the wheel load.

In a possible implementation, the obtaining a center of gravity of the forklift based on wheel loads on all wheels of the forklift includes: acquiring wheel load information values for four wheels respectively based on wheel loads on the four wheels of the forklift; and determining the center of gravity based on the wheel load information values for the four wheels, where a position of the center of gravity is shifted to a position of a wheel corresponding to a larger wheel load information value.

In a possible implementation, the determining the center of gravity based on the wheel load information values for the four wheels includes: acquiring, based on wheel load information values for two wheels of the four wheels, a first line of center of gravity perpendicular to a connection line of the two wheels, where a ratio of distances from the two wheels to the first line of center of gravity is corresponding to a ratio of the wheel load information values for the two wheels; acquiring, based on wheel load information values for the other two wheels of the four wheels, a second line of center of gravity perpendicular to a connection line of the other two wheels, where a ratio of distances from the other two wheels to the second line of center of gravity is corresponding to a ratio of the wheel load information values for the other two wheels; and determining an intersection point of the first line of center of gravity and the second line of center of gravity as the center of gravity.

According to still another aspect of the present disclosure, a possible implementation of the present disclosure provides a non-transitory computer-readable storage medium, where the non-transitory computer-readable storage medium stores computer program instructions, and when the computer program instructions are run by a processor, the processor is configured to implement the forklift overturning prevention method according to the foregoing aspects.

According to the forklift overturning prevention method in the possible implementation of the present disclosure, a wheel load on a wheel is directly acquired, a center of gravity of a forklift is acquired in real time, and when the center of gravity reaches a preset boundary line, a protection operation instruction is sent, so that the forklift stops working and sounds an alarm to prevent the forklift from overturning. Compared with the prior art, directly acquiring a wheel load on a wheel may eliminate interference of another factor and a status of the center of gravity of the forklift may be determined directly and accurately. The center of gravity of the forklift is acquired in real time, so that no matter from which position the center of gravity reaches the preset boundary line, a protection operation instruction is sent to ensure that the forklift is in a stable state in all directions, thereby preventing the forklift from overturning in different directions, in particular preventing the forklift from more dangerous left and right lateral overturning, and effectively guaranteeing safety of goods and personnel.

### BRIEF DESCRIPTION OF THE DRAWINGS

FIG. 1 is a schematic flowchart of a forklift overturning prevention method according to a possible implementation of the present disclosure.

FIG. 2 is a schematic flowchart of acquiring a wheel load on a wheel of a forklift in a forklift overturning prevention method according to a possible implementation of the present disclosure.

FIG. 3 is a schematic flowchart of acquiring a wheel load on a wheel of a forklift in a forklift overturning prevention method according to another possible implementation of the present disclosure.

FIG. 4 is a schematic flowchart of obtaining a center of gravity of a forklift in a forklift overturning prevention method according to a possible implementation of the present disclosure.

FIG. 5 is a schematic flowchart of obtaining a center of gravity of a forklift in a forklift overturning prevention method according to another possible implementation of the present disclosure.

FIG. 6 is a schematic flowchart of obtaining a center of gravity of a forklift in a forklift overturning prevention method according to another possible implementation of the present disclosure.

FIG. 7 is a schematic flowchart of obtaining a center of gravity of a forklift in a forklift overturning prevention method according to another possible implementation of the present disclosure.

FIG. 8 is a schematic diagram of wheel distribution of a forklift according to a possible implementation of the present disclosure.

FIG. 9 is a schematic structural diagram of a forklift overturning prevention apparatus according to a possible implementation of the present disclosure.

FIG. 10 is a schematic structural diagram of a forklift overturning prevention apparatus according to a possible implementation of the present disclosure.

FIG. 11 is a schematic structural diagram of an electronic device according to a possible implementation of the present disclosure.

### DETAILED DESCRIPTION OF THE EMBODIMENTS

As described in Background, there is a technical problem in a conventional technology that left and right lateral overturning of the forklift cannot be effectively prevented. The inventor has found the reasons for this problem are as follows. When a forklift performs an operation such as horizontal handling, stacking, picking, loading, and unloading, goods are placed at the front end of the forklift. Therefore, forward overturning caused by braking is more easily concerned, but leftward and rightward overturning of the forklift is often more dangerous and easily ignored. Due to neglect of problems and limitations of technologies, in the prior art, left and right lateral overturning of the forklift cannot be effectively prevented, and the more dangerous left and right lateral overturning is ignored.

In view of the foregoing technical problems, the basic concept of the present disclosure is to provide a forklift overturning prevention method, in which a wheel load on a wheel is directly acquired, a center of gravity of a forklift is acquired in real time, and when the center of gravity reaches a preset boundary line, a protection operation instruction is sent, so that the forklift stops working and sounds an alarm to prevent the forklift from overturning. Compared with the prior art, directly acquiring a wheel load on a wheel may eliminate interference of another factor and a status of the center of gravity of the forklift may be determined directly and accurately. The center of gravity of the forklift is acquired in real time, so that no matter from which position the center of gravity reaches a preset boundary line, a protection operation instruction is sent to ensure that the forklift is in a stable state in all directions, thereby preventing the forklift from overturning in different directions, in particular preventing the forklift from more dangerous left and right lateral overturning, and effectively guaranteeing safety of goods and personnel.

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts fall within the protection scope of the present disclosure.

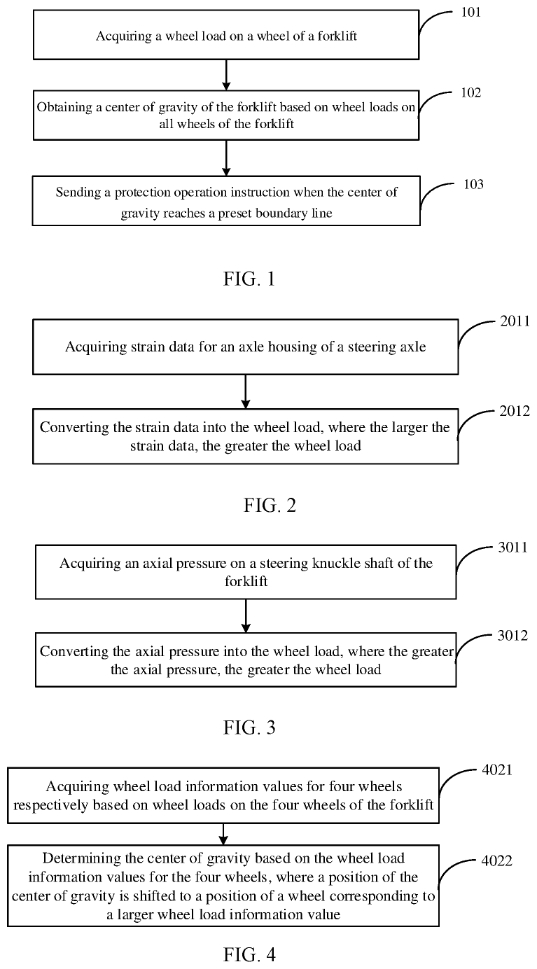

FIG. 1 is a schematic flowchart of a forklift overturning prevention method according to a possible implementation of the present disclosure. As shown in FIG. 1, the forklift overturning prevention method includes the following steps.

Step 101: acquiring a wheel load on a wheel of a forklift.

Specifically, the wheel load on a wheel is pressure of the wheel acting on a ground. Directly acquiring the wheel load on the wheel may eliminate interference of other factors such as oil pressure fluctuations in a weighing process, deflection of boom deformation, and load eccentricity, so as to directly obtain accurate data. A manner for acquiring the wheel load on the wheel is not specifically limited in this implementation. In comparison with acquiring another parameter representing a condition of the wheel, acquiring the wheel load may reduce interference of other factors such as the oil pressure fluctuations in a weighing process, the deflection of boom deformation, and the load eccentricity.

Step 102: obtaining a center of gravity of the forklift based on wheel loads on all wheels of the forklift.

Specifically, considering an impact of the wheel loads on all wheels of the forklift, the center of gravity of the forklift is obtained comprehensively, and a direction to which the position of the center of gravity is close indicates a direction at which the forklift is at risk of overturning.

Step 103: sending a protection operation instruction when the center of gravity reaches a preset boundary line.

Specifically, a position of the center of gravity of a current forklift is calculated in real time. Once the center of gravity of the forklift approaches the preset boundary line, it is determined that the forklift is in a danger of overturning, and the protection operation instruction is immediately sent, so that the forklift performs a protection operation to prevent the forklift from overturning.

In this implementation, the wheel load on the wheel is directly acquired, the center of gravity of the forklift is acquired in real time, and when the center of gravity reaches the preset boundary line, a protection operation instruction is sent, so that the forklift stops working and sounds an alarm to prevent the forklift from overturning. Compared with the prior art, directly acquiring the wheel load on the wheel may eliminate interference of another factor and a status of the center of gravity of the forklift may be determined directly and accurately. The center of gravity of the forklift is acquired in real time, so that no matter from which position the center of gravity reaches the preset boundary line, a protection operation instruction is sent to ensure that the forklift is in a stable state in all directions, thereby preventing the forklift from overturning in all directions, in particular preventing the forklift from more dangerous left and right lateral overturning, and effectively guaranteeing safety of goods and personnel.

FIG. 2 is a schematic flowchart of acquiring a wheel load on a wheel of a forklift in a forklift overturning prevention method according to a possible implementation of the present disclosure. As shown in FIG. 2, the acquiring a wheel load on a wheel of a forklift includes the following steps.

Step 2011: acquiring strain data for an axle housing of a steering axle.

Specifically, the steering axle is configured to connect a drive shaft of the forklift and a wheel of the forklift. When the wheel is pressed during transportation of the forklift, a stress deformation is generated on the axle housing. The strain data for the axle housing may reflect an axle load on the steering axle, and the axle load on the steering axle may reflect the wheel load on the wheel. The strain data is data for deformation of the axle housing due to the stress deformation. The strain data for the axle housing of the steering axle may be collected by means of a strain sensor, and the strain sensor is disposed at a position, close to a tire, on the axle housing of the steering axle.

Step 2012: converting the strain data into the wheel load, where the larger the strain data, the greater the wheel load.

Specifically, the larger the strain data, the greater the wheel load. When the strain data is converted into the wheel load, a size of the wheel load may be accurately reflected. Optionally, the relationship between the strain data and the wheel load is a proportional linear change.

FIG. 3 is a schematic flowchart of acquiring a wheel load on a wheel of a forklift in a forklift overturning prevention method according to another possible implementation of the present disclosure. As shown in FIG. 3, the acquiring a wheel load on a wheel of a forklift includes the following steps.

Step 3011: acquiring an axial pressure on a steering knuckle shaft of the forklift.

Specifically, when the wheel is pressed during transportation of the forklift, the axial pressure is generated on the steering knuckle shaft of the forklift, and the pressure on the steering knuckle shaft may reflect the wheel load on the wheel. The pressure on the steering knuckle shaft may be collected by a pressure sensor disposed on the steering knuckle shaft.

Step 3012: converting the axial pressure into the wheel load, where the greater the axial pressure, the greater the wheel load.

Optionally, the relationship between the axial pressure and the wheel load is a proportional linear change.

Specifically, the larger the axial pressure, the greater the wheel load. When the axial pressure is converted into the wheel load, a size of the wheel load may be accurately reflected.

In the foregoing two possible implementations, the wheel load on the wheel is acquired in real time through conversion, interference of another factor may be eliminated, and a status of the center of gravity of the forklift may be determined more directly and accurately.

FIG. 4 is a schematic flowchart of obtaining a center of gravity of a forklift in a forklift overturning prevention method according to a possible implementation of the present disclosure. As shown in FIG. 4, the obtaining a center of gravity of the forklift based on wheel loads on all wheels of the forklift includes the following steps.

Step 4021: acquiring wheel load information values for four wheels respectively based on wheel loads on the four wheels of the forklift.

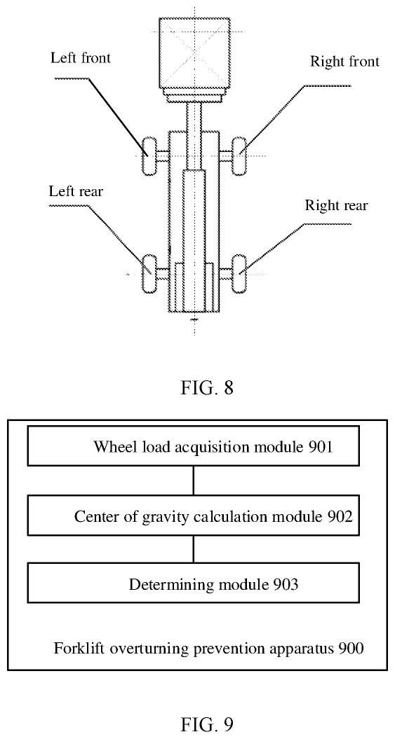

Specifically, a wheel distribution of the forklift may be as shown in FIG. 8. (FIG. 8 is a schematic diagram of wheel distribution of a forklift according to a possible implementation of the present disclosure.) The wheel load information values are proportional values obtained based on wheel load pressure values of the four wheels, and a specific calculation method may be calculating a ratio of a wheel load on a specific wheel to a sum of the wheel loads on four wheels of the forklift. A wheel load on a left front wheel, a wheel load on a left rear wheel, a wheel load on a right front wheel, and a wheel load on a right rear wheel are separately acquired, and a left front wheel load information value, a left rear wheel load information value, a right front wheel load information value, and a right rear wheel load information value are separately acquired. For example, the wheel load on the left front wheel, the wheel load on the left rear wheel, the wheel load on the right front wheel, and the wheel load on the right rear wheel are 12 KN, 25 KN, 18 KN and 15 KN, respectively, and the left front wheel load information value, the left rear wheel load information value, the right front wheel load information value, and the right rear wheel load information value are 17.14%, 35.71%, 25.71%, and 21.44%, respectively.

Step 4022: determining the center of gravity based on the wheel load information values for the four wheels, where a position of the center of gravity is shifted to a position of a wheel corresponding to a larger wheel load information value.

Specifically, the larger wheel load information value indicates a larger wheel load on a corresponding wheel, and the position of the center of gravity shifts towards a direction of the corresponding wheel. The position of the center of gravity is shifted to the position of the wheel corresponding to the larger wheel load information value, so as to obtain the center of gravity in real time. For example, the left front wheel load information value, the left rear wheel load information value, the right front wheel load information value, and the right rear wheel load information value are 17.14%, 35.71%, 25.71%, and 21.44%, respectively, where the left rear wheel load information value is larger, so that the center of gravity of the forklift should be shifted to the position of the rear left wheel.

In this implementation, the wheel load information values for the four wheels are acquired, and the center of gravity is shifted towards the direction corresponding to the larger wheel load information value, so that the center of gravity of the forklift is determined, thereby conveniently and quickly acquiring the position of the center of gravity.

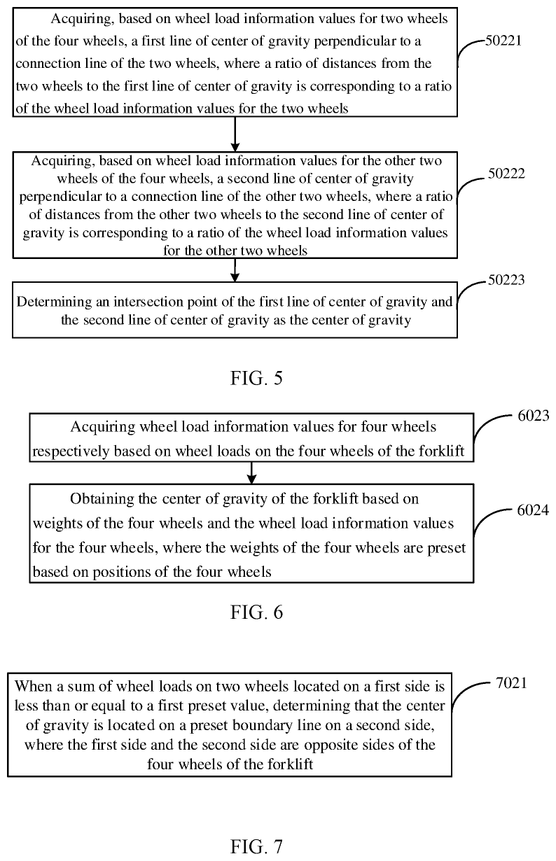

FIG. 5 is a schematic flowchart of obtaining a center of gravity of a forklift in a forklift overturning prevention method according to another possible implementation of the present disclosure. As shown in FIG. 5, the determining the center of gravity based on the wheel load information values for the four wheels includes the following steps.

Step 50221: acquiring, based on wheel load information values for two wheels of the four wheels, a first line of center of gravity perpendicular to a connection line of the two wheels, where a ratio of distances from the two wheels to the first line of center of gravity is corresponding to a ratio of the wheel load information values for the two wheels.

Specifically, the two wheels are first selected from the four wheels. The two wheels may be two wheels on the left side, two wheels on the right side, or two wheels on one of two diagonals formed by the four wheels. How to select the two wheels from the four wheels is not specifically limited in the possible implementation. For example, the left front wheel load information value, the left rear wheel load information value, the right front wheel load information value, and the right rear wheel load information value are 17.14%, 35.71%, 25.71%, and 21.44%, respectively. Front and rear wheels on the left side are selected, and wheel load information values thereof are 17.14% and 35.71%, respectively. A vertical line perpendicular to a connection line segment of the two wheels on the left side is formed, the vertical line divides the connection line segment of the two wheels on the left side into two segments, and a ratio of the two segments is the same as the ratio of 17.14% to 35.71%.

Step 50222: acquiring, based on wheel load information values for the other two wheels of the four wheels, a second line of center of gravity perpendicular to a connection line of the other two wheels, where a ratio of distances from the other two wheels to the second line of center of gravity is corresponding to a ratio of the wheel load information values for the other two wheels.

Specifically, the second line of center of gravity is acquired by using a method same as that used for the first line of center of gravity. For example, front and rear wheels on the right side are selected, and wheel load information values for the front and rear wheels on the right side are 25.71% and 21.44%, respectively. A vertical line perpendicular to a connection line segment of the two wheels on the right side is formed, the vertical line divides the connection line segment of the two wheels on the right side into two segments, and a ratio of the two segments is the same as the ratio of 25.71% to 21.44%.

Step 50223: determining an intersection point of the first line of center of gravity and the second line of center of gravity as the center of gravity.

In this implementation, a direction in which the center of gravity is shifted in a first direction is determined based on wheel load information values for the two wheels of the four wheels, a direction in which the center of gravity is shifted in a second direction is determined based on wheel load information values for the other two wheels, and a direction in which the center of gravity is shifted is obtained in combination with the two directions, thereby determining the center of gravity.

FIG. 6 is a schematic flowchart of obtaining a center of gravity of a forklift in a forklift overturning prevention method according to another possible implementation of the present disclosure. As shown in FIG. 6, the obtaining a center of gravity of the forklift based on wheel loads on all wheels of the forklift includes the following steps.

Step 6023: acquiring wheel load information values for four wheels respectively based on wheel loads on the four wheels of the forklift.

Specifically, the wheel load information values are initial wheel load information values acquired based on the wheel loads on the four wheels.

Step 6024: obtaining the center of gravity of the forklift based on weights of the four wheels and the wheel load information values for the four wheels, where the weights of the four wheels are preset based on positions of the four wheels.

Specifically, considering different working environments of the forklift, importance may be attached to different directions of overturning of the forklift. For example, when the forklift is used at a sea-land junction, more importance is attached to overturning of the forklift towards the sea side, thus requiring an increase in weight on one side. The weights of the four wheels are preset according to different application scenarios.

Calculation is performed again based on the weights of the four wheels and the wheel load information values for the four wheels acquired in Step 6023, to obtain updated wheel load information values. The center of gravity of the forklift is further determined based on the updated wheel load information values.

The method of further determining the center of gravity of the forklift based on the updated wheel load information values is the same as the method described in Step 50221, Step 50222, and Step 50223. For example, since front and rear wheels on the left side are located on the seaside, weights of the front and rear wheels on the left side are larger. A weight of the left front wheel, a weight of the left rear wheel, a weight of the right front wheel, and a weight of the right rear wheel are 0.35, 0.3, 0.15, and 0.2, respectively, and the wheel load information values for the front and rear wheels on the left side are 17.14% and 35.71%, respectively. When the first line of center of gravity is determined, a vertical line perpendicular to a connection line segment of the two wheels on the left side is formed, the vertical line divides the connection line segment of the two wheels on the left side into two segments, and a ratio of the two segments is the same as the ratio of 17.14%*0.35 to 35.71%*0.3.

In this implementation, considering different application scenarios of the forklift, significant importance is attached to overturning of the forklift on one side. Weight of this side is increased, and a magnitude of shift of the center of gravity toward the direction is increased, so that the center of gravity is easier to approach a preset boundary line in the direction, thereby reducing a probability of overturning on the side.

FIG. 7 is a schematic flowchart of obtaining a center of gravity of a forklift in a forklift overturning prevention method according to another possible implementation of the present disclosure. As shown in FIG. 7, the obtaining a center of gravity of the forklift based on wheel loads on all wheels of the forklift includes the following steps.

Step 7021: when a sum of wheel loads on two wheels located on a first side is less than or equal to a first preset value, determining that the center of gravity is located on a preset boundary line on a second side, where the first side and the second side are opposite sides of the four wheels of the forklift.

Specifically, when the sum of the wheel loads on the two wheels on the first side is less than or equal to the first preset value, it is considered that the two wheels on the first side are not subjected to pressure, and the center of gravity of the forklift is located on the preset boundary line on the second side opposite to the first side.

For example, a wheel distribution of the forklift may be as shown in FIG. 8. The wheel load on the left front wheel, the wheel load on the left rear wheel, the wheel load on the right front wheel, and the wheel load on the right rear wheel are respectively acquired.

When a sum of the wheel load on the left front wheel and the wheel load on the left rear wheel is less than or equal to the first preset value, it is indicated that the center of gravity is located at the preset boundary line on the right side, and it is determined that the forklift is in danger of rightward overturning, and thus the forklift performs a protection measure. Optionally, the preset boundary line may be a connection line of two tires on the right side.

When a sum of the wheel load on the right front wheel and the wheel load on the right rear wheel is less than or equal to the first preset value, it is indicated that the center of gravity is located at the preset boundary line on the left side, and it is determined that the forklift is in danger of leftward overturning, and thus the forklift performs a protection measure. Optionally, the preset boundary line may be a connection line of two tires on the left side.

When a sum of the wheel load on the right front wheel and the wheel load on the left front wheel is less than or equal to the first preset value, it is indicated that the center of gravity is located at the preset boundary line on the back side, and it is determined that the forklift is in danger of backward overturning, and thus the forklift performs a protection measure. Optionally, the preset boundary line may be a connection line of two tires on the back side.

When a sum of the wheel load on the right rear wheel and the wheel load on the left rear wheel is less than or equal to the first preset value, it is indicated that the center of gravity is located at the preset boundary line on the front side, and it is determined that the forklift is in danger of forward overturning, and thus the forklift performs a protection measure. Optionally, the preset boundary line may be a connection line of two tires on the front side.

It should be understood that the first preset value may be 0 N, 10 N, 50 N, 100 N, 200 N, or the like, and the first preset value is set according to a type of the forklift and a specific application scenario.

In this possible implementation, when it is determined that the sum of wheel loads on the two wheels located on a first side is less than or equal to the first preset value, it is considered that the two wheels located on the first side are not subjected to pressure. Thus, it is determined that the center of gravity is located on a preset boundary line on a second side opposite to the first side, and then it is determined that there is a potential risk of overturning of the forklift in the direction of the second side, so that a protection measure is performed to prevent the forklift from overturning.

In a possible implementation, the preset boundary line includes a combination of one or more of the following: a connection line of two front tires, a connection line of two rear tires, a connection line of two left tires, and a connection line of two right tires.

The sending a protection operation instruction when the center of gravity reaches a preset boundary line includes the following operations: when the center of gravity reaches the connection line of the two front tires, sending a protection operation instruction corresponding to forward overturning of the forklift; when the center of gravity reaches the connection line of the two rear tires, sending a protection operation instruction corresponding to backward overturning of the forklift; when the center of gravity reaches the connection line of the two left tires, sending a protection operation instruction corresponding to leftward overturning of the forklift; and when the center of gravity reaches the connection line of the two right tires, sending a protection operation instruction corresponding to rightward overturning of the forklift.

Specifically, the preset boundary line is the connection line of the two front tires, and when the center of gravity reaches the connection line of the two front tires, the protection operation instruction corresponding to forward overturning of the forklift is sent, so that the forklift performs a protection operation to prevent the forklift from forward overturning. The preset boundary line is the connection line of the two rear tires, and when the center of gravity reaches the connection line of the two rear tires, the protection operation instruction corresponding to backward overturning of the forklift is sent, so that the forklift performs a protection operation to prevent the forklift from backward overturning. The preset boundary line is the connection line of the two left tires, and when the center of gravity reaches the connection line of the two left tires, the protection operation instruction corresponding to backward overturning of the forklift is sent, so that the forklift performs a protection operation to prevent the forklift from leftward overturning. The preset boundary line is the connection line of the two right tires, and when the center of gravity reaches the connection line of the two right tires, the protection operation instruction corresponding to rightward overturning of the forklift is sent, so that the forklift performs a protection operation to prevent the forklift from rightward overturning.

In a possible implementation, protection operation instructions include: performing playback of a warning voice for forklift forward overturning, an operation of prohibiting a forklift boom from extension, and an operation of retracting a forklift boom; performing playback of a warning voice for forklift backward overturning, an operation of prohibiting a forklift boom from retraction, and an operation of extending a forklift boom; performing playback of a warning voice for forklift leftward overturning, a stopping operation of a forklift boom, and an increase in right counterweight torque; and performing playback of a warning voice for forklift rightward overturning, a stopping operation of a forklift boom, and an increase in left counterweight torque.

Specifically, when the center of gravity reaches the connection line of the two front tires, the warning voice for forklift forward overturning is played back, and the operation of prohibiting the forklift boom from extension and the operation of retracting the forklift boom are performed, so that the center of gravity is adjusted backwards to prevent the forklift from forward overturning. When the center of gravity returns to a safe position, the foregoing protection operation is stopped. When the center of gravity reaches the connection line of the two rear tires, the warning voice for forklift backward overturning is played back, and the operation of prohibiting the forklift boom from retraction, and the operation of extending the forklift boom are performed, so that the center of gravity is adjusted forwards to prevent the forklift from backward overturning. When the center of gravity returns to the safe position, the foregoing protection operation is stopped.

When the center of gravity reaches the connection line of the two left tires, the warning voice for forklift leftward overturning is played back, and operation of the forklift boom is stopped and right counterweight torque increases, so that the center of gravity is adjusted rightwards to prevent the forklift from leftward overturning. When the center of gravity returns to a safe position, the foregoing protection operation is stopped. When the center of gravity reaches the connection line of the two left tires, the warning voice for forklift rightward overturning is played back, and the operation of the forklift boom is stopped and left counterweight torque increases, so that the center of gravity is adjusted leftwards to prevent the forklift from rightward overturning. When the center of gravity returns to a safe position, the foregoing protection operation is stopped.

In this possible implementation, when the center of gravity of the forklift reaches the preset boundary line, it is determined that the forklift is in danger of overturning, and the voice alarm is played to keep staff away from the forklift, thereby ensuring safety of the staff. In addition, protection operations corresponding to different overturning directions are performed to change a position of the center of gravity of the forklift, and reduce a probability that the center of gravity continues to shift toward the preset boundary line, thereby making the forklift as stable as possible, and reducing an overturning probability.

FIG. 9 is a schematic structural diagram of a forklift overturning prevention apparatus according to a possible implementation of the present disclosure. As shown in FIG. 9, the forklift overturning prevention apparatus 900 includes: a wheel load acquisition module 901, configured to acquire a wheel load on a wheel of a forklift; a center of gravity calculation module 902, configured to obtain a center of gravity of the forklift based on wheel loads on all wheels of the forklift; and a determining module 903, configured to send a protection operation instruction when the center of gravity reaches a preset boundary line.

In this implementation, a wheel load on a wheel is directly acquired by using the wheel load acquisition module 901, a center of gravity of a forklift is acquired in real time by using the center of gravity calculation module 902, and it is determined by the determining module 903 that when the center of gravity reaches a preset boundary line, a protection operation instruction is sent, so that the forklift stops working and sounds an alarm to prevent the forklift from overturning. The forklift is ensured to be in a stable state in all directions, thereby preventing the forklift from overturning in all directions, in particular preventing the forklift from more dangerous left and right lateral overturning, and effectively guaranteeing safety of goods and personnel.

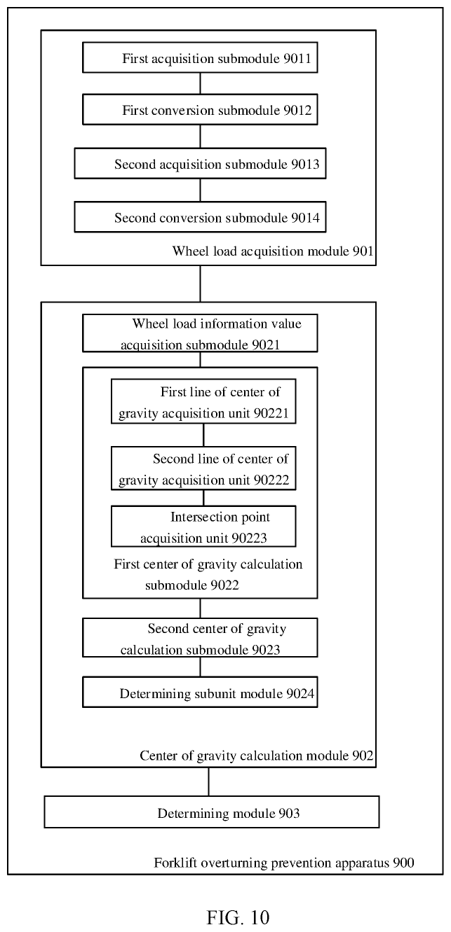

FIG. 10 is a schematic structural diagram of a forklift overturning prevention apparatus according to a possible implementation of the present disclosure. As shown in FIG. 10, the wheel load acquisition module 901 further includes: a first acquisition submodule 9011, configured to acquire strain data for an axle housing of a steering axle; and a first conversion submodule 9012, configured to convert the strain data into the wheel load, where the larger the strain data, the greater the wheel load.

In a possible implementation, as shown in FIG. 10, the wheel load acquisition module 901 further includes: a second acquisition submodule 9013, configured to acquire an axial pressure on a steering knuckle shaft of the forklift; and a second conversion submodule 9014, configured to convert the axial pressure into the wheel load, where the greater the axial pressure, the greater the wheel load.

In a further possible implementation, the first acquisition submodule 9011 is disposed in the second acquisition submodule 9013, and the first conversion submodule 9012 is disposed in the second conversion submodule 9014.

In a possible implementation, as shown in FIG. 10, the center of gravity calculation module 902 further includes: a wheel load information value acquisition submodule 9021, configured to acquire wheel load information values for four wheels respectively based on wheel loads on the four wheels of the forklift; and a first center of gravity calculation submodule 9022, configured to determine the center of gravity based on the wheel load information values for the four wheels, where a position of the center of gravity is shifted to a position of a wheel corresponding to a larger wheel load information value.

In a possible implementation, as shown in FIG. 10, the first center of gravity calculation submodule 9022 further includes: a first line of center of gravity acquisition unit 90221, configured to acquire, based on wheel load information values for two wheels of the four wheels, a first line of center of gravity perpendicular to a connection line of the two wheels, where a ratio of distances from the two wheels to the first line of center of gravity is corresponding to a ratio of the wheel load information values for the two wheels; a second line of center of gravity acquisition unit 90222, configured to acquire, based on wheel load information values for the other two wheels of the four wheels, a second line of center of gravity perpendicular to a connection line of the other two wheels, where a ratio of distances from the other two wheels to the second line of center of gravity is corresponding to a ratio of the wheel load information values for the other two wheels; and an intersection point acquisition unit 90223, configured to determine an intersection point of the first line of center of gravity and the second line of center of gravity as the center of gravity.

In a possible implementation, as shown in FIG. 10, the center of gravity calculation module 902 further includes: a wheel load information value acquisition submodule 9021, configured to preset weights of the four wheels based on positions of the four wheels; and a second center of gravity calculation submodule 9023, configured to obtain the center of gravity of the forklift based on weights of the four wheels and the wheel load information values for the four wheels, where the weights of the four wheels are preset based on positions of the four wheels.

In a possible implementation, as shown in FIG. 10, the center of gravity calculation module 902 further includes: a determining subunit module 9024, configured to: when a sum of wheel loads on two wheels located on a first side is less than or equal to a first preset value, determine that center of gravity is located on a preset boundary line on a second side, where the first side and the second side are opposite sides of the four wheels of the forklift. A forklift according to a possible implementation of the present disclosure includes: a forklift body for handling a material; a forklift overturning prevention apparatus 900 disposed on the forklift body, configured to perform the forklift overturning prevention method according to any one of the foregoing aspects; and a controller disposed on the forklift body and electrically connected to the forklift overturning prevention apparatus, configured to control the forklift body to perform a protection operation when a protection operation instruction sent by the forklift overturning prevention apparatus is received.

In this possible implementation, the forklift overturning prevention apparatus 900 detects a center of gravity of a forklift in real time by using a wheel load on a wheel. When the center of gravity reaches a preset boundary line, the forklift overturning prevention apparatus 900 sends a protection operation instruction to a controller, and the controller controls a forklift body to perform protection operations such as playing back a warning voice, prohibiting a forklift boom from extension, and lowering a forklift boom. The forklift is ensured to be in a stable state in all directions, thereby preventing the forklift from overturning in different directions, in particular preventing the forklift from more dangerous left and right lateral overturning, and effectively guaranteeing safety of goods and personnel.

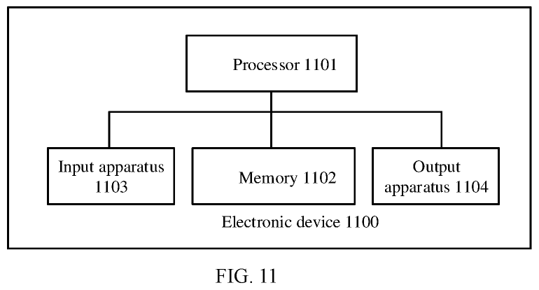

FIG. 11 is a schematic structural diagram of an electronic device according to a possible implementation of the present disclosure. As shown in FIG. 11, an electronic device 1100 includes one or more processors 1110 and a memory 1120.

The processor 1110 may be a central processing unit (CPU) or a processing unit in another form that has a data handling capacity and/or instruction execution capacity, and may control another component in the electronic device 1100 to perform a desired function.

The memory 1120 may include one or more computer program products. The computer program products may include various forms of computer-readable storage media, for example, a volatile memory and/or a non-volatile memory. The volatile memory may include, for example, a random access memory (RAM) and/or a cache memory (cache). The non-volatile memory may include, for example, a read-only memory (ROM), a hard disk, a flash memory, and the like. One or more computer program instructions may be stored in the computer-readable storage medium. The processor 1110 may run the program instructions to implement the forklift overturning prevention methods in the foregoing possible implementations of the present disclosure and/or another desired function. In an example, the electronic device 1100 may further include an input apparatus 1130 and an output apparatus 1140. These components are interconnected by using a bus system and/or another form of connection mechanism (not shown).

Certainly, for simplification, FIG. 11 shows merely some components related to the present disclosure in the electronic device 1100. Components such as a bus and an input/output interface are omitted. In addition, according to a specific application situation, the electronic device 1100 may further include any other proper components.

In addition to the foregoing methods and devices, a possible implementation of the present disclosure may alternatively be a computer program product. The computer program product includes computer program instructions. When the computer program instructions are run by a processor, the processor is enabled to perform the steps in the forklift overturning prevention methods in the possible implementations of the present disclosure described in the forklift overturning prevention method in the specification.

The computer program product may use any combination of one or more programming languages to write a program code for performing possible implementations in the present disclosure. The programming languages include an object oriented programming language, such as Java, C++, and conventional procedural programming language, such as the “C” language or a similar programming language. The program code may be entirely executed on a user's computing device, partially on a user's computing device, executed as an independent software package, partially executed on a user's computing device and partially executed on a remote computing device, or entirely executed on a remote computing device or a server.

In addition, a possible implementation of the present disclosure may alternatively be a computer-readable storage medium. The computer-readable storage medium includes computer program instructions. When the computer program instructions are run by a processor, the processor is enabled to perform the steps in the forklift overturning prevention methods in the possible implementations of the present disclosure described in the forklift overturning prevention method in the specification.

The computer-readable storage medium may employ any combination of one or more readable media. The readable medium may be a readable signal medium or a readable storage medium. The readable storage medium may include, but not limited to, electronic, magnetic, optical, electromagnetic, infrared, or semiconductor systems, apparatuses, or devices, or any combination thereof. A more specific example (a non-exhaustive list) of the readable storage medium includes an electrical connection based on one or more conducting wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage component, a magnetic storage component, or any proper combination of the foregoing content.

A basic principle of the present disclosure is described with reference to the specific possible implementations. However, it should be noted that, the advantages, merits, effects, and the like mentioned in the present disclosure are only examples but not limitations, and it cannot be considered that these advantages, merits, effects, and the like must be provided in the possible implementations of the present disclosure.

The foregoing descriptions are merely preferable embodiments of the present disclosure, but are not intended to limit the present disclosure. Any modification, equivalent replacement, and the like made without departing from the spirit and principle of the present disclosure shall fall within the protection scope of the present disclosure.

What is claimed is:

1. A forklift overturning prevention method, comprising:
acquiring a wheel load on a wheel of a forklift;
obtaining a center of gravity of the forklift based on wheel loads on all wheels of the forklift; and
sending a protection operation instruction when the center of gravity reaches a preset boundary line.

2. The forklift overturning prevention method according to claim 1, wherein the acquiring a wheel load on a wheel of a forklift comprises:
acquiring strain data for an axle housing of a steering axle, wherein the steering axle is configured to connect a drive shaft of the forklift and the wheel of the forklift; and
converting the strain data into the wheel load, wherein the larger the strain data, the greater the wheel load.

3. The forklift overturning prevention method according to claim 1, wherein the acquiring a wheel load on a wheel of a forklift comprises:
acquiring an axial pressure on a steering knuckle shaft of the forklift; and
converting the axial pressure into the wheel load, wherein the greater the axial pressure, the greater the wheel load.

4. The forklift overturning prevention method according to claim 1, wherein the obtaining a center of gravity of the forklift based on wheel loads on all wheels of the forklift comprises:
acquiring wheel load information values for four wheels respectively based on wheel loads on the four wheels of the forklift; and
determining the center of gravity based on the wheel load information values for the four wheels, wherein a position of the center of gravity is shifted to a position of a wheel corresponding to a larger wheel load information value.

5. The forklift overturning prevention method according to claim 4, wherein the determining the center of gravity based on the wheel load information values for the four wheels comprises:
acquiring, based on wheel load information values for two wheels of the four wheels, a first line of center of gravity perpendicular to a connection line of the two wheels, wherein a ratio of distances from the two wheels to the first line of center of gravity is corresponding to a ratio of the wheel load information values for the two wheels;
acquiring, based on wheel load information values for the other two wheels of the four wheels, a second line of center of gravity perpendicular to a connection line of the other two wheels, wherein a ratio of distances from the other two wheels to the second line of center of gravity is corresponding to a ratio of the wheel load information values for the other two wheels; and
determining an intersection point of the first line of center of gravity and the second line of center of gravity as the center of gravity.

6. The forklift overturning prevention method according to claim 1, wherein the obtaining a center of gravity of the forklift based on wheel loads on all wheels of the forklift comprises:
acquiring wheel load information values for four wheels respectively based on wheel loads on the four wheels of the forklift; and
obtaining the center of gravity of the forklift based on weights of the four wheels and the wheel load information values for the four wheels, wherein the weights of the four wheels are preset based on positions of the four wheels.

7. The forklift overturning prevention method according to claim 1, wherein the obtaining a center of gravity of the forklift based on wheel loads on all wheels of the forklift comprises:
when a sum of wheel loads on two wheels located on a first side is less than or equal to a first preset value, determining that the center of gravity is located on a preset boundary line on a second side, wherein
the first side and the second side are opposite sides of the four wheels of the forklift.

8. The forklift overturning prevention method according to claim 1, wherein the preset boundary line comprises a combination of one or more of the following: a connection line of two front tires, a connection line of two rear tires, a connection line of two left tires, and a connection line of two right tires.

9. The forklift overturning prevention method according to claim 8, wherein the sending a protection operation instruction when the center of gravity reaches a preset boundary line comprises:
when the center of gravity reaches the connection line of the two front tires, sending a protection operation instruction corresponding to forward overturning of the forklift.

10. The forklift overturning prevention method according to claim 8, wherein the sending a protection operation instruction when the center of gravity reaches a preset boundary line comprises:
when the center of gravity reaches the connection line of the two rear tires, sending a protection operation instruction corresponding to backward overturning of the forklift.

11. The forklift overturning prevention method according to claim 8, wherein the sending a protection operation instruction when the center of gravity reaches a preset boundary line comprises:
when the center of gravity reaches the connection line of the two left tires, sending a protection operation instruction corresponding to leftward overturning of the forklift.

12. The forklift overturning prevention method according to claim 8, wherein the sending a protection operation instruction when the center of gravity reaches a preset boundary line comprises:
when the center of gravity reaches the connection line of the two right tires, sending a protection operation instruction corresponding to rightward overturning of the forklift.

13. The forklift overturning prevention method according to claim 1, wherein the protection operation instruction comprises:
performing playback of a warning voice for forklift forward overturning, an operation of prohibiting a forklift boom from extension, and an operation of retracting a forklift boom; or
performing playback of a warning voice for forklift backward overturning, an operation of prohibiting a forklift boom from retraction, and an operation of extending a forklift boom; or
performing playback of a warning voice for forklift leftward overturning, a stopping operation of a forklift boom, and an increase in right counterweight torque; or
performing playback of a warning voice for forklift rightward overturning, a stopping operation of a forklift boom, and an increase in left counterweight torque.

14. A forklift, comprising:
a forklift body for handling a material;
a forklift overturning prevention apparatus disposed on the forklift body, configured to perform the forklift overturning prevention method according to claim 1; and
a controller disposed on the forklift body and electrically connected to the forklift overturning prevention apparatus, configured to control the forklift body to perform a protection operation when a protection operation instruction sent by the forklift overturning prevention apparatus is received.

15. A non-transitory computer-readable storage medium, wherein the non-transitory computer-readable storage medium stores computer program instructions, and when the computer program instructions are run by a processor, the processor is configured to implement the forklift overturning prevention method according to claim 1.

16. An electronic device, wherein the electronic device comprises:
a processor;
a memory, and
computer program instructions stored in the memory, wherein when the computer program instructions are run by the processor, the processor is configured to implement the forklift overturning prevention method, the method comprising the follow steps:
acquiring a wheel load on a wheel of a forklift;
obtaining a center of gravity of the forklift based on wheel loads on all wheels of the forklift; and
sending a protection operation instruction when the center of gravity reaches a preset boundary line.

17. The electronic device according to claim 16, wherein the acquiring a wheel load on a wheel of a forklift comprises:
acquiring strain data for an axle housing of a steering axle, wherein the steering axle is configured to connect a drive shaft of the forklift and the wheel of the forklift; and
converting the strain data into the wheel load, wherein the larger the strain data, the greater the wheel load.

18. The electronic device according to claim 16, wherein the acquiring a wheel load on a wheel of a forklift comprises:
acquiring an axial pressure on a steering knuckle shaft of the forklift; and
converting the axial pressure into the wheel load, wherein the greater the axial pressure, the greater the wheel load.

19. The electronic device according to claim 16, wherein the obtaining a center of gravity of the forklift based on wheel loads on all wheels of the forklift comprises:
acquiring wheel load information values for four wheels respectively based on wheel loads on the four wheels of the forklift; and
determining the center of gravity based on the wheel load information values for the four wheels, wherein a position of the center of gravity is shifted to a position of a wheel corresponding to a larger wheel load information value.

20. The electronic device according to claim 19, wherein the determining the center of gravity based on the wheel load information values for the four wheels comprises:
acquiring, based on wheel load information values for two wheels of the four wheels, a first line of center of gravity perpendicular to a connection line of the two wheels, wherein a ratio of distances from the two wheels to the first line of center of gravity is corresponding to a ratio of the wheel load information values for the two wheels;
acquiring, based on wheel load information values for the other two wheels of the four wheels, a second line of center of gravity perpendicular to a connection line of the other two wheels, wherein a ratio of distances from the other two wheels to the second line of center of gravity is corresponding to a ratio of the wheel load information values for the other two wheels; and
determining an intersection point of the first line of center of gravity and the second line of center of gravity as the center of gravity.
